(19) United States
(12) Patent Application Publication
(10) Pub. No.: US 2006/0242042 A1
(43) Pub. Date: Oct. 26, 2006

(54) Calculating tax amount where multiple tax types may apply

(76) Inventors: Richard Qin, Shanghai (CN); Ari Schapira, Zichron Ya'akov (IL); Ye Zhang, Shanghai (CN); Michael Sun, Shanghai (CN); Diamond Song, Shanghai (CN); Chen Wu, Shanghai (CN); Jeff Zeng, Shanghai (CN); Hua Wang, Shanghai (CN)

Correspondence Address: FISH & RICHARDSON, P.C., PO BOX 1022, MINNEAPOLIS, MN, 55440-1022, US

(21) Appl. No.: 11/113,832

(22) Filed: Apr. 25, 2005

(51) Int. Cl. G06Q 20/00; G06Q 40/00

(52) U.S. Cl. 705/35; 705/19

(57) ABSTRACT

A computer program product for calculating a tax amount where multiple types of taxes may apply to a transaction is tangibly embodied in an information carrier and includes first data structures comprising tax formulas. Each of the tax formulas is associated with one of several tax types. The computer program product includes second data structures comprising tax combinations of the several tax types, each tax combination having associated therewith at least one of the several tax types, one of the tax combinations to be selected for use with a specific transaction. The computer program product includes executable instructions that when executed determine, from information associated with the specific transaction, which one of the tax combinations to use in calculating a tax amount for the specific transaction, the tax amount to be calculated using the formula associated with any of the tax types included in the selected tax combination.

### TECHNICAL FIELD

The description relates to calculating, in a computer system, a tax amount for a transaction when multiple types of tax may apply.

### BACKGROUND

Taxes are administered and collected in many jurisdictions, regions or countries of the world. Particularly, the occurrence of a financial transaction such as a sale of goods or services may trigger tax liabilities according to one or more tax types of a specific region. In many areas, determining an applicable tax amount involves a complicated calculation that depends on several different parameters, some of which may be unique to the transaction at hand. Where several tax types apply, the final tax calculation may be a combination of these several tax types. Moreover, the system needs a selection mechanism for choosing the correct tax type(s) to apply in a given situation. Changes in tax laws occur from time to time, and the system therefore needs to be flexible so that it can be adapted to such changes.

### SUMMARY

The invention relates to calculating a tax amount when multiple tax types may apply.

In a first general aspect, a computer program product to be used in calculating a tax amount where multiple types of taxes may apply to a transaction, tangibly embodied in an information carrier, comprises first data structures comprising tax formulas, each of the tax formulas being associated with one of several tax types. The computer program product further comprises second data structures comprising tax combinations of the several tax types, each tax combination having associated therewith at least one of the several tax types, one of the tax combinations to be selected for use with a specific transaction. The computer program product further comprises executable instructions that when executed determine, from information associated with the specific transaction, which one of the tax combinations to use in calculating a tax amount for the specific transaction, the tax amount to be calculated using the formula associated with any of the tax types included in the selected tax combination.

In selected embodiments, upon one of the tax combinations being selected, there is displayed, to a user, input parameters and output parameters of the formula associated with any of the tax types included in the selected tax combination. The computer program product may further comprise a third data structure comprising tax type categories, each of the several tax types being associated with one of the tax type categories, wherein upon selection of a specific one of the tax type categories, there is presented the tax types associated with the selected tax type category. The computer program product may further comprise a third data structure comprising parameter sets for each of the respective tax formulas, each parameter set including at least one input parameter and at least one output parameter for the tax formula. Upon a specific one of the tax types being included in one of the tax combinations, a determination may be made whether the specific tax formula requires an input that is to be obtained using another of the tax formulas. The computer program product may further comprise a data structure editing module, wherein the first and second data structures are created with user input made using the data structure editing module. Third data structures may be created using the data structure editing module, the third data structures comprising tax type combinations, each tax type combination being associated with several tax types and their corresponding formulas. The data structure editing module may provide that the user cannot edit a specific one of the tax type combinations if it is already included in one of the tax combinations. The user may create a specific one of the tax combinations by associating one of the tax type combinations with a parameter set, the parameter set including input parameters and output parameters of the formula associated with any of the tax types included in the specific tax combination. Upon the user selecting the tax type combination, the data structure editing module may identify any matching parameter sets from several parameter sets. The computer program product may further comprise a priority list of several criteria, each of the criteria being associated with one of the tax combinations, the executable instructions to evaluate the several criteria, in order, using the information associated with the specific transaction, until a match is detected or the priority list is exhausted. The executable instructions may include several alternative priority lists, one of them to be selected using the information associated with the specific transaction.

In a second general aspect, a computer program product to be used in calculating a tax amount where multiple types of taxes may apply to a transaction, tangibly embodied in an information carrier, comprises:

first data structures comprising tax type categories, each tax type category having associated therewith at least one of several tax types;

second data structures comprising tax formulas, each of the tax formulas being associated with one of the several tax types;

third data structures comprising tax type combinations, each tax type combination having associated therewith at least one of the several tax types and an associated at least one of the tax formulas;

fourth data structures comprising parameter sets for each of the tax formulas, each parameter set including at least one input parameter and at least one output parameter for the tax formula;

fifth data structures comprising tax combinations of the several tax types, each tax combination having associated therewith at least one of the several tax types and at least one of the parameter sets, one of the tax combinations to be selected for use with a specific transaction; and

executable instructions that when executed determine, from information associated with the specific transaction, which one of the tax combinations to use in calculating a tax amount for the specific transaction, the tax amount to be calculated using the formula associated with any of the tax types included in the selected tax combination.

In a third general aspect, a system for calculating a tax amount where multiple types of taxes may apply to a transaction comprises a transaction management module for managing transactions for which multiple types of taxes may apply, each transaction being associated with specific information. The system further comprises a tax calculating module for calculating a tax amount for any of the transactions. The tax calculating module includes first data structures comprising tax formulas, each of the tax formulas being associated with one of several tax types. The tax calculating module further includes second data structures comprising tax combinations of the several tax types, each tax combination having associated therewith at least one of the several tax types. The tax calculating module is to select one of the tax combinations for use with a specific transaction. The tax calculating module further includes executable instructions for the tax calculating module to determine, from the specific information associated with the specific transaction, which one of the tax combinations to use in calculating a tax amount for the specific transaction, the tax amount to be calculated using the formula associated with any of the tax types included in the selected tax combination.

In selected embodiments, the tax calculating module includes a priority list of several criteria, each of the criteria being associated with one of the tax combinations, the several criteria to be evaluated, in order, using the specific information associated with the specific transaction, until a match is detected or the priority list is exhausted. The tax calculating module may include several alternative priority lists, one of them to be selected using the information associated with the specific transaction. Upon one of the tax combinations being selected, the tax calculation module may display, to a user, input parameters and output parameters of the formula associated with any of the tax types included in the selected tax combination.

Advantages of the systems and techniques described herein may include any or all of the following: Providing an improved tax calculation system for calculating a tax amount where multiple types of tax may apply; providing a tax calculating system with increased flexibility; providing an improved determination of the applicable tax type among multiple tax types.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system that calculates a tax amount;

FIGS. 2A and 2B are examples of graphical user interfaces (GUIs) that the FIG. 1 system can display upon calculating the tax amount;

FIG. 3 is an example of a GUI in which a user can define a tax parameter to be used in calculating a tax amount;

FIGS. 4A and 4B are examples of GUIs in which a user can define attributes and return values, respectively, to be used with a particular tax type;

FIG. 5 is an example of a GUI in which a user can define a tax type to be used in calculating a tax amount;

FIG. 6 is an example of a GUI in which a user can define values for attributes of a specific tax type;

FIG. 7 is an example of a GUI in which a user can define a tax formula for a specific tax type;

FIG. 8 is an example of a GUI in which a user can define a tax type combination that includes several tax types;

FIG. 9 is an example of a GUI in which a user can define a tax combination that is associated with at least one tax type and its corresponding tax parameters;

FIG. 10A is an example of a GUI in which a user can define a priority list for determining which tax combination to apply to a specific transaction;

FIG. 10B is an example of a GUI in which a user can define key field values for the FIG. 10A priority list; and

FIG. 11 is a block diagram of a general computer system.

Like reference numerals in the various drawings indicate like elements.

### DETAILED DESCRIPTION

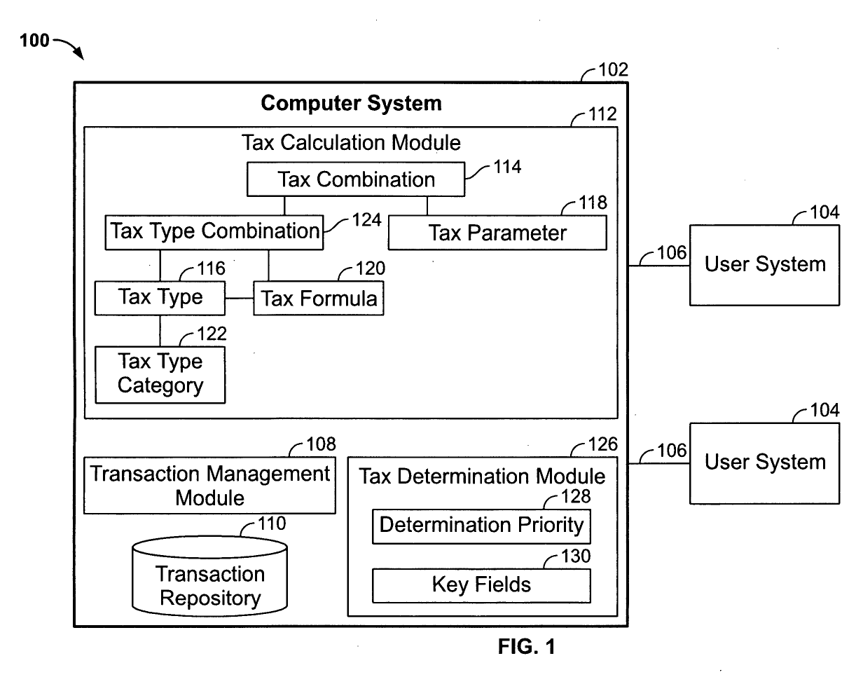

FIG. 1 shows a system 100 that manages transactions and that can calculate one or more tax amounts relating to any of the transactions. The system 100 includes a computer system 102 and at least one user system 104 that is connected to the computer system 102 through any connection 106, such as a computer network. A user may access the computer system 102 through any of the user systems to manage, or to trigger a tax calculation for, one or more transactions that give rise to tax liability.

The computer system 102 includes a transaction management module 108 that is used in initiating, defining, performing, documenting and following up on transactions such as sales orders or service orders. For example, the transaction management module allows a user to initiate a new sales order through the user system. The system may store initiated transactions and their related documentation in a transaction repository 110. In some implementations, the computer system 102 receives electronic records of transactions over a computer network, correctly interprets the specifics of each received transaction record and updates the transaction repository accordingly. Thus, the repository 110 may contain several sales orders that are managed by the system 100.

The computer system 102 includes a tax calculation module 112 that calculates a tax amount for any or all transactions in the system. For example, the module 112 can calculate the tax that applies to the sale of a specific product to a buyer in a specific country. The calculation is performed using information associated with the transaction, such as the nature of the sold product, the purchase amount and the buyer's address. What information is relevant for the tax calculation often varies between different tax systems, as well as between different tax types in a single system. The tax calculation module 112 is flexible and adaptive, so that it is useful in different taxation scenarios where more than one tax type may apply.

The tax calculation module calculates a tax amount by applying one of several tax combinations 114 to a specific transaction. The tax combination 114 is associated with one or more tax types 116 and a tax parameter 118 for the associated tax type. The tax type is associated with a tax formula 120 that is used in calculating the tax amount according to the tax type. The tax parameter 118 may be a set of input and output parameters to be used in the tax formula. The tax type may be defined as an instance of a tax type category 122. That is, there may be several tax types stemming from the same tax type category 122. In situations where more than one of the tax types may apply to the transaction(s), a tax type combination 124 may be defined. The tax type transaction groups one or more tax types, and the corresponding tax formula(s), for collective association with the tax combination 114. Following are concrete examples of the components in, and operation of, the tax calculation module 112.

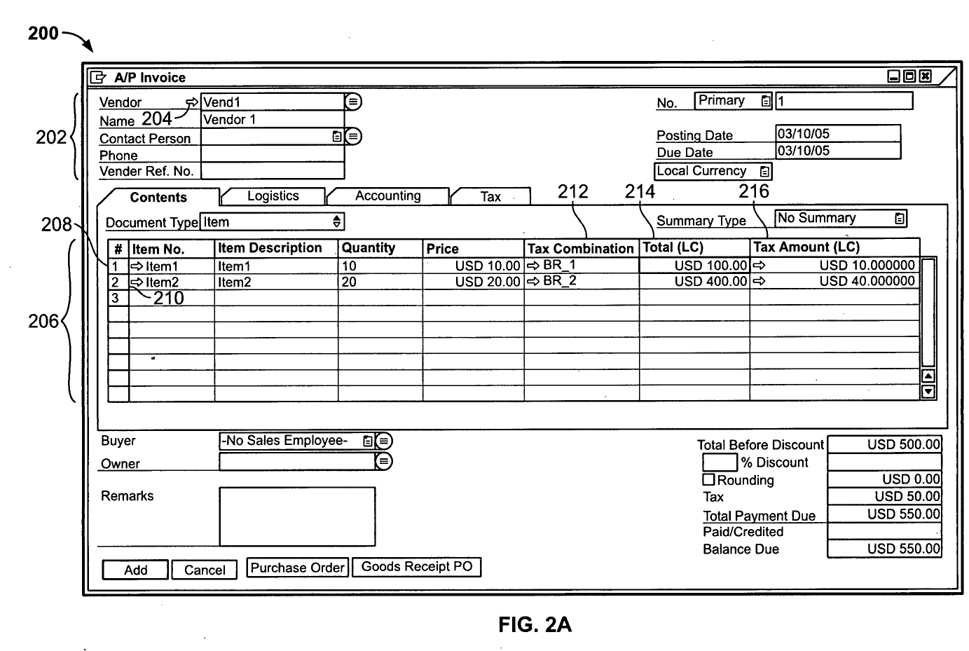

FIG. 2A shows a GUI 200 that the tax calculation module 112 can generate. The GUI 200 relates to a specific one of a general category of transactions; here, an invoice received from a seller named “Vendor 1”, as indicated in a vendor information area 202. A navigation arrow 204 next to displayed information indicates that the user can navigate to a specific screen for that information, for example by clicking the arrow using a pointing device. An item information area 206 lists one or more products or services that are covered by the transaction. Here, a first item 208 and a second item 210 are listed. Each item has an item number, an item description and a quantity assigned to it. Moreover, a tax combination column 212 indicates which of the tax combinations 114 applies to the specific item. Here, a first tax combination “BR_{—}1” applies to the first item and a second tax combination “BR_{—}2” applies to the second item. The difference in tax combinations may depend on the nature of the products, their shipping destination, or other factors.

A total amount column 214 lists the total sales amount for the respective items: $100 for the first item (ten items at $10 apiece) and $400 for the second item (20 items at $20 apiece). Applying the proper tax combination to these respective totals yields the results listed in a tax amount column 216, namely $10 for the first item and $40 for the second item.

The user can click on the tax amounts listed in column 216 to see how the separate tax types that make up the applied tax combination contribute to the tax amount. This may lead to the tax calculating module displaying a GUI 250 as shown in FIG. 2B. The GUI 250 has a tax combination field 252 identifying the applied tax combination (here BR_{—}1), and a name field 254 presenting a name for that tax combination (here: ICMS+IPI+ST). The name may reflect the separate tax types that are included in the tax combination. For example, ICMS, IPI and ST are common monikers for tax types in the Brazilian tax system.

A tax type presentation area 256 specifies the amount contributed by any and all tax types included in the tax combination. Here, a first tax type (ICMS) contributes $18, for example. A total field 258 corresponds to the entry in the tax amount column 216 (the numbers in FIG. 2B differs from the numbers in FIG. 2A because they relate to different transactions). Thus, the GUIs 200 and 250 are a convenient way for the user to review the tax amount calculated by the tax calculating module 112. Following are some examples of a user entering the definitions by which the tax calculation module is configured.

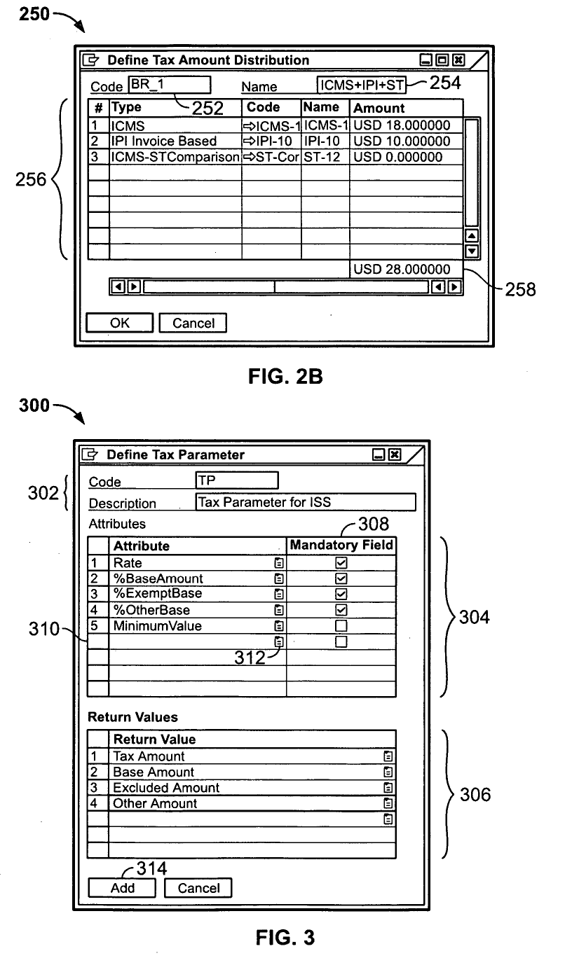

FIG. 3 shows a GUI 300 for defining one or more sets of tax parameters 118. The tax parameters represent the input and output parameter(s) for the tax formula of a specific tax type. Thus, when the GUI 300 has been completed for a specific tax type, it provides a convenient overview of its inputs and outputs. The user enters a name for the tax parameter (here: TP) and a description (here: Tax Parameter for ISS) in a header area 302. The GUI 300 includes an attribute definition area 304 listing defined input parameters (or “attributes”) and a return values definition area 306 listing defined output parameters (or “return values”). The attribute definition area 304 lists five exemplary attributes: Rate, % Base Amount, % ExemptBase, % OtherBase and MinimumValue. According to a column 308, the first four attributes are mandatory for the tax type. The return values definition area 306 lists four exemplary return values: Tax Amount, Base Amount, Excluded Amount and Other Amount. The user can define an additional attribute or return value in a blank row of the respective areas 304 or 306. For example, the user types the description of a new attribute in a blank line 310, or selects from a list of existing attributes by selecting an icon 312. The defined tax parameter(s) can be saved in the tax calculation module with an Add control 314.

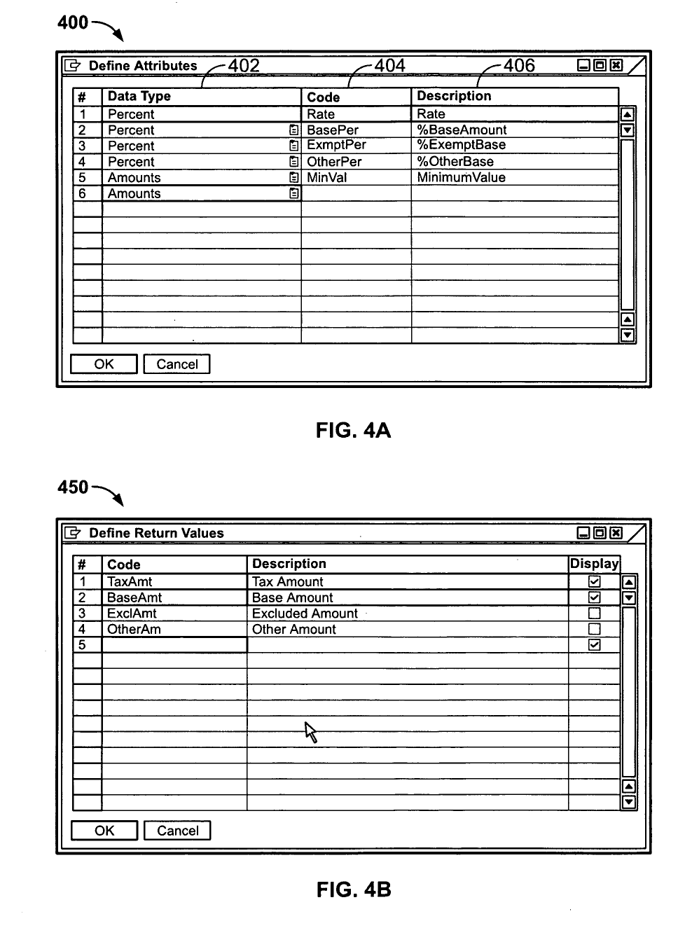

The respective attributes and return values may belong to different data types, as will now be described with reference to FIGS. 4A and 4B. A GUI 400 lets the user define a new attribute a) as being of a specific data type (column 402); b) as being identified by a particular code (column 404); and c) as having a certain description (column 406). For example, the GUI 400 here includes the definitions for the five attributes Rate, % Base Amount, % ExemptBase, % OtherBase and MinimumValue, the first four being of the type “Percent” and the fifth of the type “Amounts”. Thus, upon the user defining a new attribute in the GUI 400, it may be displayed as a selectable attribute upon the user selecting the icon 312 in the GUI 300. Similarly, in a GUI 450, the user has defined the four return values Tax Amount, Base Amount, Excluded Amount and Other Amount. Accordingly, the GUIs 300, 400 and 450 can be used in defining any or all of the tax parameters 118.

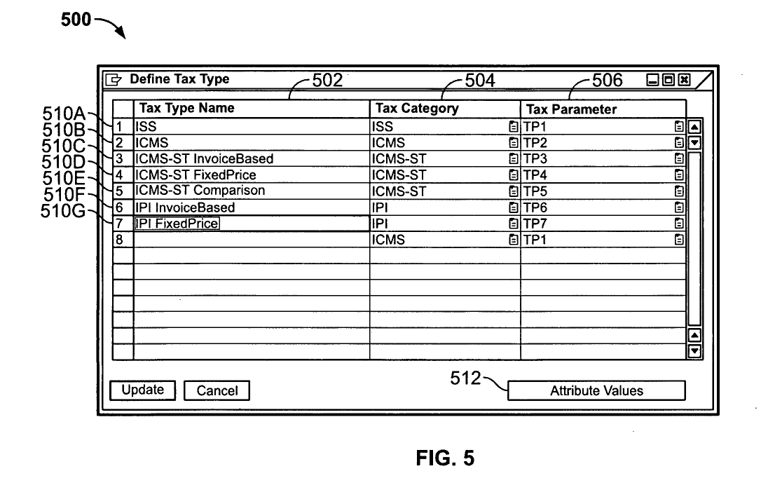

FIG. 5 shows a GUI 500 in which a user can define the tax types 116. Each tax type is defined by its name (column 502), its association with one of the tax type categories 122 (column 504) and a tax parameter (column 506) with which it is associated. Exemplary tax types 510A-G are shown. Two or more tax types may belong to a common tax category, for example the tax types 510C-E (tax type category ICMS-ST) and the tax types 510F-G (tax type category IPI). An attribute values control 512 leads to a screen for entering values for the tax parameter that is associated with a selected tax type, as will now be described.

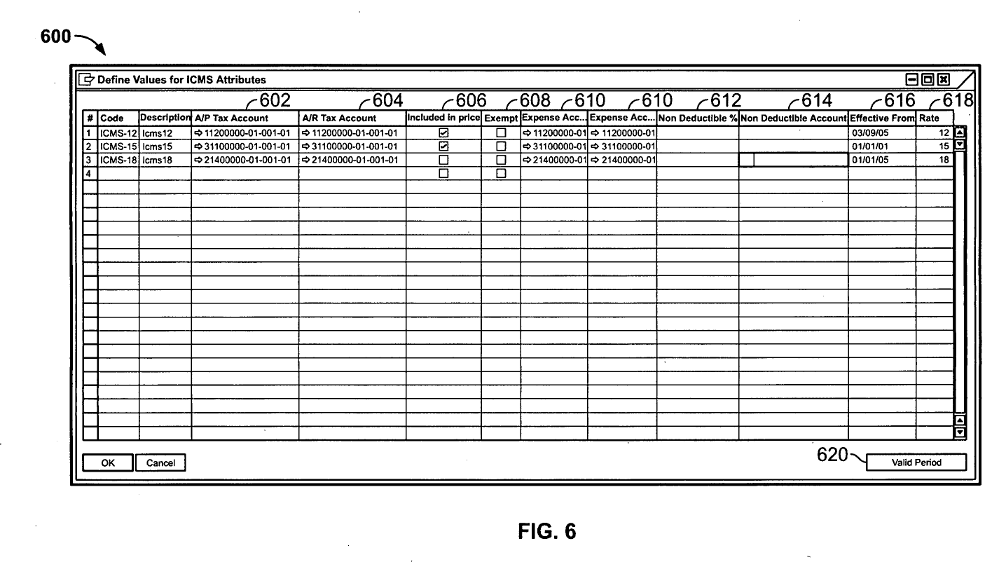

FIG. 6 shows a GUI 600 by which the user can enter definitions for one or more of the attributes for a specific tax type. Here, the tax parameters of the ICMS tax type are being presented. The formula of this tax type can receive three attributes: ICMS-12, ICMS-15 and ICMS-18. Each of them is defined by respective entries in an accounts payable tax account column 602, an accounts receivable tax account column 604, an “Included in price” column 606, an Exempt column 608, Expense accounts columns 610, a Non-deductible percentage column 612, a Non-deductible account column 614, an Effective From column 616 and a Rate column 618. Particularly, the different attributes have respective rates 12, 15 and 18 (percent) in the Rate column 618. The entry in the Effective From column 616 can be defined in a separate screen using a Valid Period control 620.

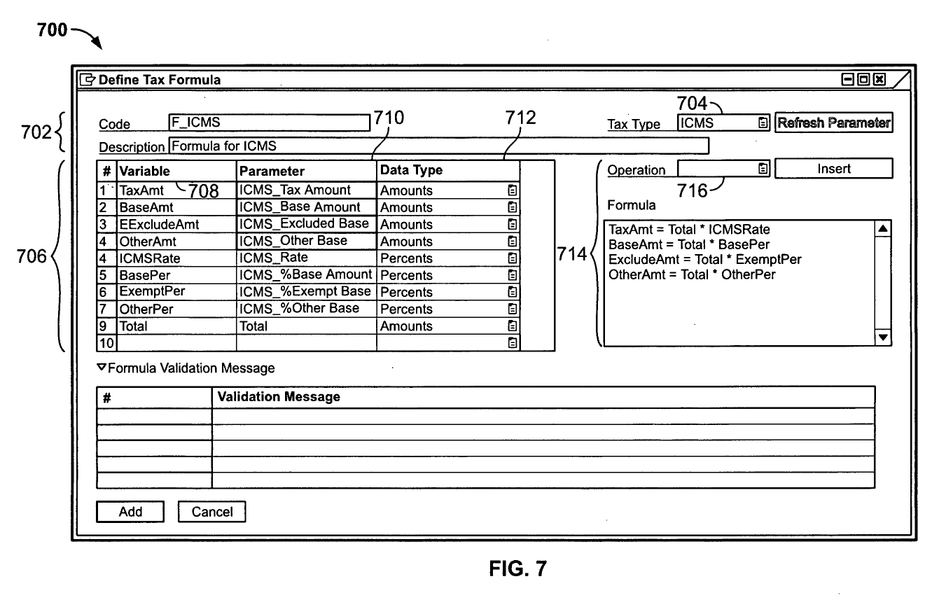

The calculation of a tax amount is performed using the one(s) of the tax formulas 120 that is/are associated with the tax type(s) 116 of the selected tax combination 114. FIG. 7 shows a GUI 700 generated by the tax calculation module for a user to define a specific formula. In a formula identification field 702, the user enters a formula code (here: F_ICMS) and a description (here: Formula for ICMS). In a tax type identification field 704, the user enters the tax type with which the formula is to be identified. A tax parameter area 706 lists the parameters for the selected tax type (column 708), the tax parameters that will provide the values for the parameter (column 710) and the data type of the parameter (column 712). Accordingly, the area 706 gives an overview of the input and output parameters of the formula.

The user defines the tax formula in an area 714. For example, the return value TaxAmt is defined as the product of the Total parameter and the ICMSRate parameter. As another example, the return value BaseAmt is defined as “Total*BasePer”, using the parameters Total and BasePer. Any operations used in the formula, such as multiplication which is represented by the “*” character, may be selected using an operation field 716. The field 716 may receive arithmetic operators or condition operators, for example any or all of the following:

Arithmetic Operations:
+
−
*
/
%
(
)
Round(Number, Decimals as Number)
Round(Number, Type)
Condition Operations:
<
<=
==
!=
>=
>
if . . . else

Thus, the area 714 lets the user define the formula 120 for calculating one or more tax amounts.

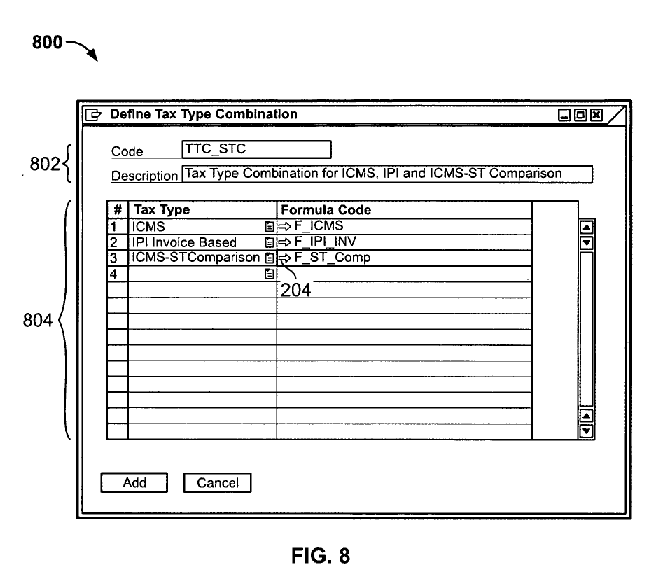

The tax types 116 may be grouped in one or more tax type combinations 124. FIG. 8 shows a GUI 800 by which a user can define such a tax type combination. The GUI 800 includes an identification area 802 in which the user enters for the tax type combination a Code (here: TTC_STC) and a Description (here: Tax Type Combination for ICMS, IPI and ICMS-ST Comparison). The GUI 800 includes a tax type area 804 in which the user lists one or more tax types, and associated formulas, to be included in the tax type combination. In some implementations, the system enters the correct formula upon the user specifying one of the tax types. The tax formulas may be provided with the navigation arrow 204 so that the user can navigate to the GUI 700 for the selected formula. Accordingly, the GUI 800 lets the user group tax types so that they can collectively be assigned to a specific tax combination 114.

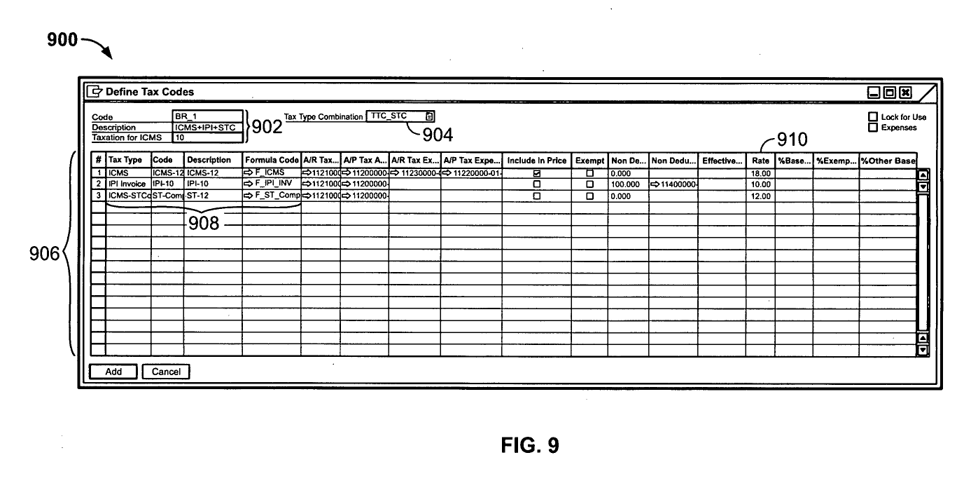

FIG. 9 shows a GUI 900 in which the user can define the tax combination(s) 114. The GUI 900 includes an information area 902 where the user enters for the tax combination a Code (here: BR_{—}1), a Description (here: ICMS+IPI+ST) and a rate value regarding Taxation for ICMS (here: 10). In a tax type combination field 904, the user selects one of the tax type combinations 124 on which to base the current tax combination. The selection of a tax type combination informs the system which tax types are at issue (for example, this association is shown in the GUI 800). Moreover, each of the formulas for the tax types has associated therewith its respective tax parameter(s). Thus, the GUI can display, in a details area 906, the specifics for each of the included tax types. For example, the tax types and their formulas are identified by the entries in columns 908, and the tax parameters are defined in remaining columns, including a Rate column 910. Thus, the GUI 900 also gives the user an overview of the various tax types included in the selected tax combination.

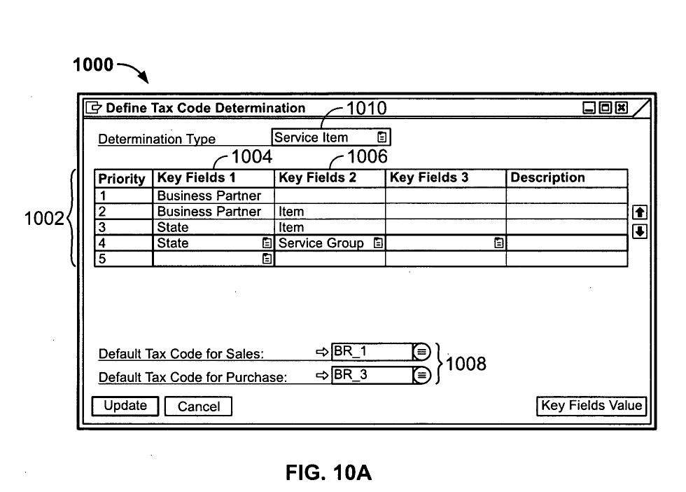

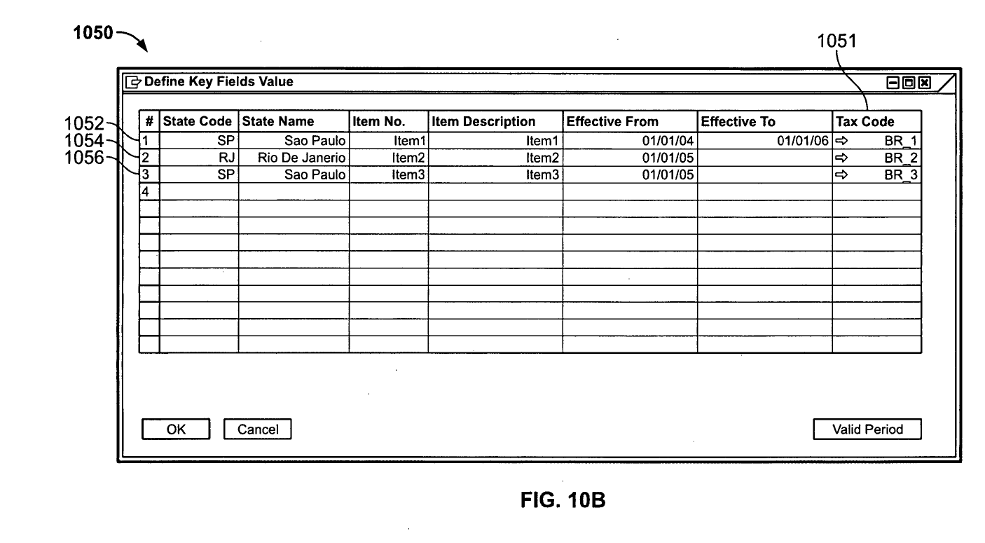

The computer system 102 includes a tax determination module 126 that is used in selecting the correct one of the tax combinations 114 for a specific transaction. The tax determination module 126 uses a determination priority 128 which may include a priority list of several criteria, and key fields 130 which provide the values for the criteria listed in the determination priority 128. An example will be described with reference to FIGS. 10A and 10B. A GUI 1000 lets the user create or modify the priority 128. Particularly, the user can create, in a priority area 1002, a list that prioritizes the order in which the key fields of the transaction are evaluated. As priority number 1, the current list specifies in column 1004 that the field “Business Partner” should first be looked at. The predefined value of the “Business Partner” field is associated with a specific one of the tax combinations 114. If there is a match in the evaluation of the first priority, the tax calculation module will use the specific tax combination in calculating the tax amount. If, in contrast, no match is detected the evaluation continues with the next priority. Particularly, a second priority lists “Business Partner” in column 1004 and “Item” in column 1006, and a third priority lists “State” in column 1004 and “Item” in column 1006. The evaluation continues until a match is detected or the priority list is exhausted. A default area 1008 lets the user specify one or more default tax combinations to be used if no match is detected.

The system may include several determination priorities 128 that apply to different transaction contexts, wherein the correct priority list is to be selected in view of the transaction at issue. For example, the priority list shown in GUI 1000 applies to a “Service Item” according to a field 1010.

The association between individual values of the key fields and the tax combination to be used can be defined using a GUI 1050 shown in FIG. 10B. The GUI 1050 currently lists exemplary combinations of states and items. Any or all of the combinations can be used in evaluating the third priority shown in GUI 1000, each value set being associated with a specific tax combination in a column 1051 of the GUI 1050. For example, a first value set 1052 includes the state code for Sao Paulo (SP) associated with “Item1”. If the transaction involves shipment of “Item1” to a customer in Sao Paulo, the tax combination BR_{—}1 will be used, according to column 1051. A second value set 1054 matches the state code for Rio de Janeiro (RJ) and “Item2” with a tax combination BR_{—}2, and a third value set 1056 the state code for Sao Paulo and “Item3” with a tax combination BR_{—}3, respectively. Accordingly, the GUI 1050 lets the user specify the tax combination to be used for various sets of values in the key fields prioritized according to the GUI 1000.

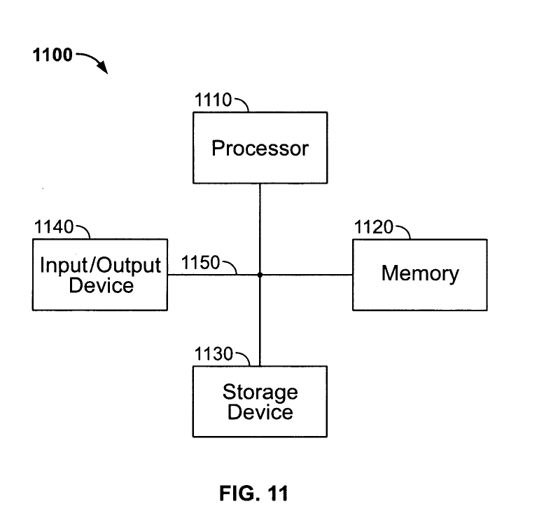

FIG. 11 is a block diagram of a computer system 1100 that can be used in the operations described above, for example in the computer system 102 or in the user system 104. The system 1100 includes a processor 1110, a memory 1120, a storage device 1130 and an input/output device 1140. Each of the components 1110, 1120, 1130 and 1140 are interconnected using a system bus 1150. The processor 1110 is capable of processing instructions for execution within the system 1100. In one embodiment, the processor 1110 is a single-threaded processor. In another embodiment, the processor 1110 is a multi-threaded processor. The processor 1110 is capable of processing instructions stored in the memory 1120 or on the storage device 1130 to display graphical information for a user interface on the input/output device 1140. For example, any and all of the components of the tax calculation module or the tax determination module may be a data structure that is stored and used in the system. Similarly, the tax calculation module and the tax determination module may comprise executable instructions that when executed cause the system to perform the various operations of the modules.

The memory 1120 stores information within the system 1100. In one embodiment, the memory 1120 is a computer-readable medium. In one embodiment, the memory 1120 is a volatile memory unit. In another embodiment, the memory 1120 is a non-volatile memory unit.

The storage device 1130 is capable of providing mass storage for the system 1100. In one embodiment, the storage device 1130 is a computer-readable medium. In various different embodiments, the storage device 1130 may be a floppy disk device, a hard disk device, an optical disk device, or a tape device.

The input/output device 1140 provides input/output operations for the system 1100. In one embodiment, the input/output device 1140 includes a keyboard and/or pointing device. In one embodiment, the input/output device 1140 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer program product to be used in calculating a tax amount where multiple types of taxes may apply to a transaction, the computer program product being tangibly embodied in an information carrier and comprising:
first data structures comprising tax formulas, each of the tax formulas being associated with one of several tax types;
second data structures comprising tax combinations of the several tax types, each tax combination having associated therewith at least one of the several tax types, one of the tax combinations to be selected for use with a specific transaction; and
executable instructions that when executed determine, from information associated with the specific transaction, which one of the tax combinations to use in calculating a tax amount for the specific transaction, the tax amount to be calculated using the formula associated with any of the tax types included in the selected tax combination.

2. The computer program product of claim 1, wherein upon one of the tax combinations being selected, there is displayed, to a user, input parameters and output parameters of the formula associated with any of the tax types included in the selected tax combination.

3. The computer program product of claim 1, further comprising a third data structure comprising tax type categories, each of the several tax types being associated with one of the tax type categories, wherein upon selection of a specific one of the tax type categories, there is presented the tax types associated with the selected tax type category.

4. The computer program product of claim 1, further comprising a third data structure comprising parameter sets for each of the respective tax formulas, each parameter set including at least one input parameter and at least one output parameter for the tax formula.

5. The computer program product of claim 4, wherein upon a specific one of the tax types being included in one of the tax combinations, a determination is made whether the specific tax formula requires an input that is to be obtained using another of the tax formulas.

6. The computer program product of claim 1, further comprising a data structure editing module, wherein the first and second data structures are created with user input made using the data structure editing module.

7. The computer program product of claim 6, wherein third data structures are created using the data structure editing module, the third data structures comprising tax type combinations, each tax type combination being associated with several tax types and their corresponding formulas.

8. The computer program product of claim 7, wherein the data structure editing module provides that the user cannot edit a specific one of the tax type combinations if it is already included in one of the tax combinations.

9. The computer program product of claim 7, wherein the user creates a specific one of the tax combinations by associating one of the tax type combinations with a parameter set, the parameter set including input parameters and output parameters of the formula associated with any of the tax types included in the specific tax combination.

10. The computer program product of claim 9, wherein upon the user selecting the tax type combination, the data structure editing module identifies any matching parameter sets from several parameter sets.

11. The computer program product of claim 1, further comprising a priority list of several criteria, each of the criteria being associated with one of the tax combinations, the executable instructions to evaluate the several criteria, in order, using the information associated with the specific transaction, until a match is detected or the priority list is exhausted.

12. The computer program product of claim 11, wherein the executable instructions include several alternative priority lists, one of them to be selected using the information associated with the specific transaction.

13. A computer program product to be used in calculating a tax amount where multiple types of taxes may apply to a transaction, the computer program product being tangibly embodied in an information carrier and comprising:
first data structures comprising tax type categories, each tax type category having associated therewith at least one of several tax types;
second data structures comprising tax formulas, each of the tax formulas being associated with one of the several tax types;
third data structures comprising tax type combinations, each tax type combination having associated therewith at least one of the several tax types and an associated at least one of the tax formulas;
fourth data structures comprising parameter sets for each of the tax formulas, each parameter set including at least one input parameter and at least one output parameter for the tax formula;
fifth data structures comprising tax combinations of the several tax types, each tax combination having associated therewith at least one of the several tax types and at least one of the parameter sets, one of the tax combinations to be selected for use with a specific transaction; and
executable instructions that when executed determine, from information associated with the specific transaction, which one of the tax combinations to use in calculating a tax amount for the specific transaction, the tax amount to be calculated using the formula associated with any of the tax types included in the selected tax combination.

14. A system for calculating a tax amount where multiple types of taxes may apply to a transaction, the system comprising:
a transaction management module for managing transactions for which multiple types of taxes may apply, each transaction being associated with specific information; and
a tax calculating module for calculating a tax amount for any of the transactions, the tax calculating module including:
first data structures comprising tax formulas, each of the tax formulas being associated with one of several tax types;
second data structures comprising tax combinations of the several tax types, each tax combination having associated therewith at least one of the several tax types, the tax calculating module to select one of the tax combinations for use with a specific transaction; and
executable instructions for the tax calculating module to determine, from the specific information associated with the specific transaction, which one of the tax combinations to use in calculating a tax amount for the specific transaction, the tax amount to be calculated using the formula associated with any of the tax types included in the selected tax combination.

15. The system of claim 14, wherein the tax calculating module includes a priority list of several criteria, each of the criteria being associated with one of the tax combinations, the several criteria to be evaluated, in order, using the specific information associated with the specific transaction, until a match is detected or the priority list is exhausted.

16. The system of claim 15, wherein the tax calculating module includes several alternative priority lists, one of them to be selected using the information associated with the specific transaction.

17. The system of claim 14, wherein upon one of the tax combinations being selected, the tax calculation module displays, to a user, input parameters and output parameters of the formula associated with any of the tax types included in the selected tax combination.
